(19) United States
(12) Patent Application Publication
(10) Pub. No.: US 2013/0108781 A1
(43) Pub. Date: May 2, 2013

(54) Methods for the Production of Cathode and Anode Powder Precursors

(71) Applicant: Simbol Inc., Pleasanton, CA (US)

(72) Inventors: Stephen Harrison, Benicia, CA (US); Son T. Nguyen, Lake Jackson, TX (US)

(73) Assignee: Simbol Inc., Pleasanton, CA (US)

(21) Appl. No.: 13/665,348

(22) Filed: Oct. 31, 2012

Related U.S. Application Data
(60) Provisional application No. 61/553,672, filed on Oct. 31, 2011.

(51) Int. Cl. H01M 4/04

(52) U.S. Cl. 427/126.3

(57) ABSTRACT

This invention relates to a method for preparing cathode powder precursors for application in lithium ion batteries.

### RELATED APPLICATIONS

This application claims priority to U.S. Provisional Patent Application No. 61/553,672, filed on Oct. 31, 2011, the disclosure of which is incorporated herein in its entirety.

### BACKGROUND OF THE INVENTION

1. Technical Field of the Invention

The invention generally relates to the field of cathode powders. More particularly, the invention relates to methods for the preparation of cathode powder precursors.

2. Description of the Prior Art

Lithium ion batters are widely used in many portable devices. One of the most critical components of the lithium ion battery is the cathode powder, which has become the main determinant of both the cost and performance of the battery system. It is understood that certain lithium ion batteries do not have sufficient power density for the desired use, such as for use in electric vehicles. The use of certain fine cathode particles and high packing densities are known methods for improving power density. In this regard, nano-sized particles have been researched extensively, including for use in lithium ion batteries.

Prior art methods for the preparation of cathode powders generally requires intimate mixing of the lithium carbonate and metal, which requires expensive equipment and inefficient thermal processing techniques of the resulting mixtures, including long residence times in ovens and furnaces. The products, in addition to being expensive to produce, are frequently poor in quality and thus are often rejected for use in batteries. Furthermore, specialized and expensive equipment is requred to achieve good battery performance from the various cathode and anode materials. Many of the current technologies rely upon intimate mixing of the components to achieve uniform stoichiometry as well as assuring similar particle size. These methods, however, are limited to small batches of cathode powders and typically include long processing times.

Lithium iron phosphate (LiFePO₄) powders have become favorable cathode materials due to low cost, high discharge potential, large specific capacity, and high abundance. Thus, high performance LiFePO₄ powders are in high demand.

The preparation of cathode powders, particularly lithium ion phosphate powders, for use in lithium ion battery applications frequently requires a thermal processing step that relies upon a certain degree of intimate mixing of the precursors and that the intimate mixing is uniform throughout the entire mixture. Thus, there is a need for additional means for preparing lithium based cathode powders that address the problems associated with insufficient mixing of the reactants, which in turn results in poor quality products.

### SUMMARY OF THE INVENTION

Methods for the preparation of cathode and anode powders are provided.

In one embodiment, a method for preparing cathode powders is provided. The method comprises the steps of: preparing a solution rich in lithium carbonate and lithium bicarbonate by bubbling carbon dioxide into a lithium carbonate containing solution; adding to the solution a metal oxide or metal phosphate compound; adding to the solution a hydroxide solution; intimately mixing the solution to cause precipitation of lithium oxide on the outer surface of the metal oxide or metal phosphate compound to produce a metal particle having a lithium carbonate coating thereon; collecting the coated metal particle; and thermally treating the metal particle to produce a lithium oxide coating on the metal particle.

In an alternate embodiment, a lithium carbonate-rich solution is combined with a metal oxide or metal phosphate compound, and heated, thereby resulting in the deposition of lithium carbonate on the surface of the metal oxide or metal phosphate compound. The compound can be collected, dried and heated to convert the lithium carbonate coating to lithium oxide, along with the corresponding evolution of carbon dioxide.

In an alternate embodiment, a metal oxide or metal phosphate compound is combined in an aqueous solution with lithium hydroxide. The solution was mixed intimately. At a temperature of at least 75° C., carbon dioxide was bubbled through the solution, resulting in the precipitation of lithium carbonate on the surface of the metal oxide or metal phosphate. The resulting particles can be washed, dried and then heated to evolve carbon dioxide, resulting in a lithium oxide coating on the metal oxide or metal phosphate compound.

### DETAILED DESCRIPTION OF THE INVENTION

Broadly, in one aspect, methods are described herein for the preparation of novel cathode powder compositions

Lithium batteries can be used as a power source for various portable devices due to their high power density and high discharge voltage. It is believed that use of fine particles of cathode materials are desirable for high power output by lithium batteries because of the resulting larger surface area of the cathode. It is also understood that uniform stoichiometry of the precursors at both the macro and micro levels will lead to improved capacity, lifetime, and long term stability.

Lithium that is used for the preparation of cathode powders is typically supplied to the mixture as lithium carbonate. Other lithium sources may also be suitable. Lithium carbonate is typically mixed with metal oxides and metal phosphates in the preparation of cathode powders. In certain embodiments, a stoichiometric excess of lithium relative to the metal oxide/metal phosphate is employed, such as between about 1 and 1.1 equivalents of lithium to the metal oxide/metal phosphate, alternatively between about 1.01 and 1.08, alternatively between about 1.01 and 1.05, alternatively between about 1.05 and 1.1, alternatively between about 1.03 and 1.08. Exemplary metal oxides include cobalt oxide, nickel oxide, manganese oxide, aluminum oxide, and the like. Exemplary metal phosphates include iron phosphate, for example. It is understood that one of skill in the art may find additional metal oxides and phosphates that are suitable for use in the preparation of cathode powders. In certain embodiments, mixed metal oxides and phosphates can also be used to prepare cathode powders. Exemplary mixed metal oxides include mixtures that include nickel, cobalt, and manganese oxides, or alternatively nickel, manganese, and aluminum oxides.

In one embodiment, a method is provided for preparing cathode powder compositions by the precipitation of a lithium salt on the surface of a metal compound. For example, in certain embodiments, a lithium salt, such as lithium carbonate, can be precipitated on the surface of a metal compound, such as ferric phosphate (FePO₄). In preparation, the metal oxide or phosphate core can be coated in its entirety with lithium carbonate.

In certain embodiments, the overall thickness of the lithium oxide layer on the metal core is of minimal importance provided it is roughly proportional to the amount of metal oxide present in the metal core. Thus, in certain embodiments, a stoichiometric or greater amount of lithium, relative to the metal core or phosphate, is provided.

The resulting cathode powder composition can then be thermally treated by heating to a temperature of greater than about 500° C., alternatively at least about 525° C.; alternatively between about 500 and 650° C., alternatively between about 525 and 575° C. Thermal treatment of the particles results in decomposition of lithium carbonate, thereby precipitating lithium oxide on the surface of the metal core, and the evolution of carbon dioxide. It is also believed that the thermal treatment of the cathode powder composition will result in the diffusion of at least part of the lithium into the metal core.

In certain embodiments, the product of the present reaction provides a cathode powder composition having greater capacity and discharge potential, for example a specific capacity of greater than about 100 mAh/g, alternatively greater than about 150 mAh/g, alternatively greater than about 160 mAh/g, alternatively greater than about 170 mAh/g, alternatively greater than about 175 mAh/g, alternatively greater than about 180 mAh/g, alternatively greater than about 190 mAh/g, or alternatively greater than about 200 mAh/g. In certain embodiments, the specific capacity is greater than about 210 mAh/g, alternatively greater than about 225 mAh/g, alternatively greater than about 250 mAh/g. In certain embodiments, the cathode powder composition of the present reaction can provide a cathode powder having a discharge potential of at least about 3 V, alternatively at least about 3.2 V, alternatively at least about 3.4 V, alternatively at least about 3.6 V, alternatively at least about 3.7 V, alternatively at least about 3.8 V, alternatively at least about 3.9 V, or alternatively at least about 4 V.

In certain embodiments, the capacity of the materials prepared according to the methods described herein have capacities that are at least about 20% greater than corresponding materials prepared utilizing prior art methods. Alternatively, the materials have capacities that are at least about 30% greater than corresponding materials prepared utilizing prior art methods. Table 1, provided below, provides certain typical capacities for cathode materials prepared from a variety of sources.

TABLE 1

| | | | | Theoretical |
|---|---|---|---|---|
| | | Specific | Specific | Specific |
| | Voltage | Capacity | Energy | Capacity |
| | (V) | (mA h/g) | (kW h/kg) | (mA h/g) |
| LiCoO₂ | 3.7 | 140 | 0.518 | 273 |
| LiMn₂O₄ | 4.0 | 100 | 0.40 | 146 |
| LiNiO₂ | 3.5 | 180 | 0.63 | 276 |
| LiFePO₄ | 3.3 | 150 | 0.495 | 171 |
| LiCo_{1/3}Ni_{1/3}Mn_{1/3}O₂ | 3.6 | 160 | 0.576 | 279 |
| Li(LiₐNiₓMn_{y}Co_{z})O₂ | 4.2 | 220 | 0.92 | |

One main advantage to the method of precipitating the lithium salt on the surface of the metal compound, as compared with the prior art methods that include intimate mixing of the constituent reactants, is greater consistency in the quality of the cathode powder product composition produced by the present methods. Higher quality and more consistent product means that smaller amounts of the cathode powder compositions are rejected for use in batteries.

In a first embodiment, lithium carbonate, preferably having a purity of greater than 97%, alternatively greater than 99%, is added to water to produce a lithium carbonate-rich solution. To the solution is added carbon dioxide by bubbling said carbon dioxide into the water, preferable at a temperature near room temperature. Optional purification can be done by filtration or like means. To the lithium carbonate-rich solution was added a metal phosphate or oxide compound such that a stoichiometric excess of lithium to metal of between about 1 and 1.15, alternatively between about 1.01 and 1.1, alternatively between about 1.05 and 1.1, preferably wherein the metal is selected from iron, vanadium, nickel, cobalt and manganese, and an alkali metal or alkaline earth hydroxide, such as lithium hydroxide, which results in the precipitation of lithium carbonate on the surface of the metal phosphate or metal oxide. In certain embodiments, the stoichiometric ratio of lithium to metal oxide is greater than about 1, alternatively between about 1:1 and 1.1:1, alternatively between about 1.01:1 and 1.05:1. The compound can be collected, washed, and then heated to convert the lithium carbonate to lithium oxide, with the corresponding evolution of carbon dioxide.

One example of the method above is provided for preparing a coated metal core particle includes the following steps. A lithium carbonate-rich solution is prepared by adding approximately 45 g of lithium carbonate to water sufficient to make a one liter of solution (having a concentration of between about 0.5M and 1M) of lithium carbonate. Carbon dioxide gas is bubbled into the lithium carbonate solution at a temperature of about 20° C. to generate soluble lithium bicarbonate solution. Optionally, the solution can be purified by microfiltration and/or ion exchange to produce a concentrated lithium bicarbonate and/or lithium carbonate solution. Exemplary means for purifying the lithium bicarbonate and/or lithium carbonate solution are described, for example, in U.S. Pat. No. 6,048,507, the disclosure of which is incorporated herein by reference in its entirety.

In an exemplary embodiment, approximately 112 kg of the concentrated lithium bicarbonate and/or lithium carbonate solution is added to approximately 27 kg of iron phosphate and mixed to ensure that the reactants were fully dispersed in solution. To the solution was added approximately 41 kg of a 10% solution of lithium hydroxide. Addition of the lithium hydroxide results in the precipitation of lithium carbonate on the surface of the iron phosphate. Control of the precipitation allows for control of the stoichiometry of the resulting particles to be maintained.

In an alternate procedure for preparing cathode powders, the lithium carbonate coated metal core can be prepared by combining the solution and metal core as above, but then heating the solution to evolve carbon dioxide and precipitate lithium carbonate on the metal core. In certain embodiments, the solution is heated to a temperature greater than about 300° C., alternatively at least about 400° C., alternatively at least about 500° C.

In an alternate embodiment, a metal oxide or metal phosphate compound, for example iron phosphate, can be added to a lithium hydroxide solution until they are well mixed. The solution can be heated to a temperature of at least about 75° C., alternatively at least about 90° C., and through the solution is bubbled carbon dioxide, thereby precipitating lithium carbonate on the metal particles.

In certain embodiments, the metal core can be vanadium oxide, nickel oxide, cobalt oxide, manganese oxide, iron phosphate, vanadium phosphate, manganese phosphate, or mixtures thereof. It is understood that the mixed metal cores can include two, three, four, five or more metals, and can include any possible mole ratio of metals.

Following precipitation of the lithium carbonate on the surface of the metal core, the solids are collected by filtration or other known means, allowed to dry or alternatively heated to increase the rate of drying. Optionally, the collected solids can be washed with cold water. The solids can then be thermally treated for up to about 2 hours, for example, heated to a temperature of at least about 550° C., alternatively at least about 650° C., alternatively at least about 750° C., alternatively at least about 800° C. Following thermal treatment, the cathode powder can be cooled, and collected. Advantageously, using the coated particles described herein unexpectedly allows for a much shorter thermal treatment time. For example, using the particles described herein, the thermal treatment times can be reduced from about 12 to 18 hours to less than two hours.

In certain embodiments described herein, the lithium carbonate utilized for the precipitation has a purity of at least about 99%, alternatively at least about 99.5%, alternatively at least about 99.9%.

In certain embodiments, the cathode powder formulation can include a dopant, such as a niobium based dopant. In certain embodiments, Nb₂O₅ can be used as a dopant.

In certain embodiments, carbon materials, such as graphite, carbon black, acetylene black, carbon nanotubes, and the like can be added to the cathode powder formulation as a dopant.

In certain embodiments, additional materials can be added to the cathode powder compositions to enhance certain properties, such as conductivity. These particles are known in the art and are generally added in relatively small amounts, for example, less than 10% by weight of the total composition.

It is understood that upon thermal treatment of the lithium carbonate coated metal particles, a certain amount of the lithium oxide coating diffuses into the metal oxide or metal phosphate core.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these reference contradict the statements made herein.

As used herein, recitation of the term about and approximately with respect to a range of values should be interpreted to include both the upper and lower end of the recited range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

We claim:

1. A method for preparing cathode powders, wherein the method comprises the steps of:
preparing a solution rich in lithium carbonate and lithium bicarbonate by bubbling carbon dioxide into a lithium carbonate containing solution;
adding to the solution a metal oxide compound;
adding to the solution a hydroxide solution;
intimately mixing the solution to cause precipitation of lithium oxide on the outer surface of the metal oxide to produce a metal particle having a lithium carbonate coating thereon;
collecting the coated metal particle; and
thermally treating the metal particle to convert the lithium carbonate coating to lithium oxide.

2. The method of claim 1, wherein the metal oxide is selected from nickel oxide, manganese oxide, nickel oxide, vanadium oxide, or combinations thereof.

3. The method of claim 1, wherein the hydroxide solution is lithium hydroxide.

4. The method of claim 1, wherein the ratio of lithium to metal oxide is greater than about 1:1.

5. The method of claim 1, wherein the ratio of lithium to metal oxide is between about 1:1 and 1.1:1.

6. The method of claim 1, wherein the ratio of lithium to metal oxide is between about 1.01:1 and 1.05:1.

7. A method for preparing cathode powders, wherein the method comprises the steps of:
preparing a solution rich in lithium carbonate and lithium bicarbonate by bubbling carbon dioxide into a lithium carbonate containing solution;
adding to the solution a metal phosphate compound;
adding to the solution a hydroxide solution;
intimately mixing the solution to cause precipitation of lithium oxide on the outer surface of the metal phosphate to produce a metal particle having a lithium carbonate coating thereon;
collecting the coated metal particle; and
thermally treating the metal particle to convert the lithium carbonate coating to lithium oxide.

8. The method of claim 7, wherein the metal phosphate is selected from iron phosphate, manganese phosphate, vanadium phosphate, or combinations thereof.

9. The method of claim 7, wherein the hydroxide solution is lithium hydroxide.

10. The method of claim 7, wherein the ratio of lithium to metal oxide is greater than about 1:1.

11. The method of claim 7, wherein the ratio of lithium to metal oxide is between about 1:1 and 1.1:1.

12. The method of claim 7, wherein the ratio of lithium to metal oxide is between about 1.01:1 and 1.05:1.
